(19) United States
(12) Patent Application Publication
(10) Pub. No.: US 2011/0211345 A1
(43) Pub. Date: Sep. 1, 2011

(54) LIGHT OUTPUT DEVICE

(75) Inventors: Dirk Kornelis Gerhardus De Boer, Eindhoven (NL); Mark Thomas Johnson, Eindhoven (NL); Sander Jurgen Roosendaal, Brno (CZ); Patrick John Baesjou, Eindhoven (NL); Hugo Johan Cornelissen, Eindhoven (NL)

(73) Assignee: KONINKLIJKE PHILIPS ELECTRONICS N.V., EINDHOVEN (NL)

(21) Appl. No.: 12/674,175

(22) PCT Filed: Aug. 22, 2008
(86) PCT No.: PCT/IB08/53380

§ 371 Date: Feb. 19, 2010

(30) Foreign Application Priority Data
Aug. 27, 2007 (EP) 07115004.9

(51) Int. Cl. F21V 11/00

(52) U.S. Cl. 362/235

(57) ABSTRACT

A light output device comprises at least one discrete light source device (4) integrated into the structure of a substrate arrangement (1,2,5) and an electrophoretic switchable light control device (40,42; 50; 60,62; 80,82), comprising a controllable region or regions associated with the at least one light source device (4), the electrophoretic switchable light control device (40,42; 50; 60,62; 80,82) being stacked with the substrate arrangement. The electrophoretic device can be used to alter the light output of the light source array, for example providing focusing and/or redirection. This enables the structure of the light source array to be kept simple. The light source array can essentially function as the backlight for the electrophoretic control device.

### FIELD OF THE INVENTION

This invention relates to light output devices, in particular using discrete light sources associated with a transparent substrate structure.

### BACKGROUND OF THE INVENTION

One known example of this type of lighting device is a so-called “LED in glass” device. An example is shown in FIG. 1. Typically a glass plate is used, with a transparent conductive coating (for example ITO) forming electrodes. The conductive coating is patterned in order to make the electrodes, that are connected to a semiconductor LED device. The assembly is completed by laminating the glass, with the LEDs inside a thermoplastic layer (for example polyvinyl butyral, PVB).

Applications of this type of device are shelves, showcases, facades, office partitions, wall cladding, and decorative lighting. The lighting device can be used for illumination of other objects, for display of an image, or simply for decorative purposes.

One problem with this type of device is that it is difficult to provide a structure which enables the illumination characteristics to be altered, for example focusing of the light source output or directional control.

### SUMMARY OF THE INVENTION

According to the invention, there is provided a light output device comprising:
at least one discrete light source device integrated into the structure of a substrate arrangement;
an electrophoretic switchable light control device, comprising a controllable region or regions associated with the at least one light source device, the electrophoretic switchable light control device being stacked with the substrate arrangement.

In this arrangement, the electrophoretic device can be used to alter the light output of the light source, for example providing focusing and/or redirection. This enables the structure of the light source to be kept simple. The light source array can essentially function as the backlight for the electrophoretic control device. The device may comprise a plurality (e.g. an array) of light source devices.

The light source devices can comprise an LED device or a group of LED devices, for example inorganic LEDs, organic LEDs, polymer LEDs or laser diodes.

The light source devices are preferably arranged in an array with a spacing between light source devices of at least 0.5 cm, more preferably at least 1 cm and even more preferably at least 2 cm. The light source array is thus a simple low cost device.

The substrate arrangement of the plurality of light source devices may comprise first and second transparent substrates and an electrode arrangement embedded in the substrate arrangement, with the plurality of light source devices connected to the electrode arrangement. This provides a light source array device which can be almost fully transparent when not providing a light output, for example for use as a window, glass ceiling or other transparent decorative lighting product. A thermoplastic or resin layer can be provided between the substrates. The electrode arrangement can be formed of a transparent conductive material, for example a transparent metal oxide.

The top glass plate of the substrate arrangement can form a bottom substrate of the electrophoretic light control device, so that an integrated structure is provided.

The electrophoretic switchable light control device may comprise scattering electrophoretic particles.

The amount and directionality of scattering can then be manipulated by changing the particle concentration above the light source devices.

In other arrangements, the electrophoretic switchable light control device can comprises particles arranged to diffract light or to change the refractive properties of the medium.

For example, the electrophoretic switchable light control device can comprise particles with a first refractive index in a liquid of a different refractive index. When the particles are in the path of light from a light output device, the effective refractive index is altered, and this can then implement a lens or light redirection function.

In particular, a relatively low concentration of suspended particles in the medium can give rise to a higher or lower refractive index than a relatively high concentration of suspended particles.

The electrophoretic switchable light control device can comprise particles and a suspending liquid which are enclosed in a cavity formed within a body. The refractive indices of the body, liquid and particles can all be chosen to obtain the desired optical effects, and change in optical effects when particles are moved into and out of the path of light from the light source devices.

The electrophoretic switchable light control device may comprise particles which are controllable movable substantially perpendicularly to control electrodes (transverse switching) and/or substantially laterally between control electrodes (in-plane switching).

The invention also provides a method of providing a light output, comprising:
generating a light output from at least one discrete light source device integrated into the structure of a substrate arrangement;
controlling the light output using an electrophoretic switchable light control device stacked with the substrate arrangement, by controlling a region or regions of the electrophoretic switchable light control device associated with the at least one light source device.

It is noted that the invention relates to all possible combinations of features recited in the claims.

### BRIEF DESCRIPTION OF THE DRAWINGS

Examples of the invention will now be described in detail with reference to the accompanying drawings, in which:

FIG. 1 shows a known LED in glass illumination device;

FIG. 2 shows a single LED of the device of FIG. 1 in more detail;

FIG. 3 shows how an in-plane electrophoretic control device can operate;

FIG. 4 shows a first example of electrophoretic control device that can be used in the device of the invention;

FIG. 5 shows a second example of electrophoretic control device that can be used in the device of the invention;

FIG. 6 shows a third example of electrophoretic control device that can be used in the device of the invention;

FIG. 7 shows a fourth example of electrophoretic control device that can be used in the device of the invention; and

FIG. 8 shows an example of light output device of the invention.

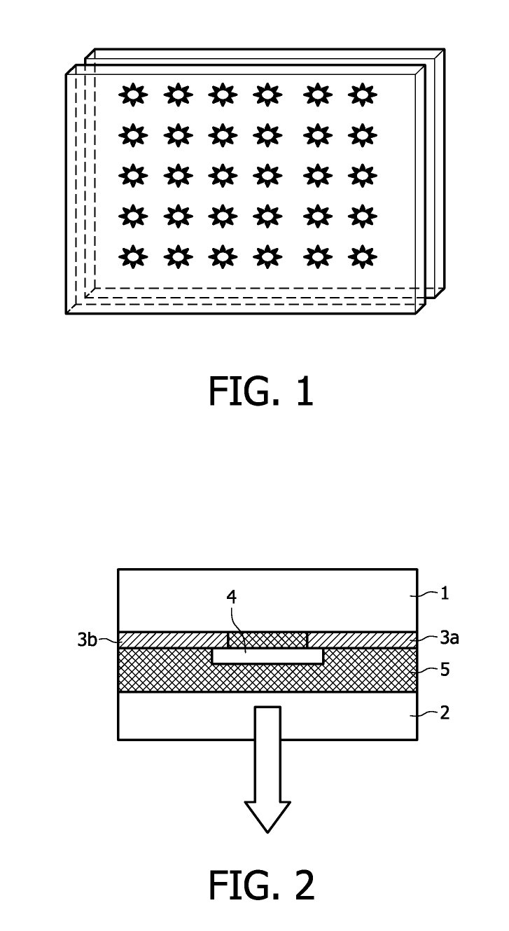

The same reference numbers are used to denote similar parts in the different figures.

### DETAILED DESCRIPTION

The structure of an LED in glass illumination device is shown in FIG. 2. The lighting device comprises glass plates 1 and 2. Between the glass plates are (semi-) transparent electrodes 3a and 3b (for example formed using ITO), and a LED 4 connected to the transparent electrodes 3a and 3b. A layer of thermoplastic material 5 is provided between glass plates 1 and 2 (for example PVB or UV resin).

The glass plates typically may have a thickness of 0.1 mm-5 mm. The spacing between the electrodes connecting to the LED is typically 0.01-3 mm, for example around 0.15 mm. The thermoplastic layer has a typical thickness of 0.3 mm-2 mm, and the electrical resistance of the electrodes is in the range 2-80 Ohm, or 10-30 Ohms/square.

The electrodes are preferably substantially transparent, so that they are imperceptible to a viewer in normal use of the device. If the conductor arrangement does not introduce a variation in light transmission (for example because it is not patterned, or because the pattern cannot be seen), a transparency of greater than or equal to 50% may be sufficient for the system to be transparent. More preferably, the transparency is greater than 70%, more preferably 90%, and even more preferably 99%. If the conductor arrangement is patterned (for example because thin wires are used), the transparency is preferably greater than 80%, more preferably 90%, but most preferably greater than 99%.

The electrodes can be made of a transparent material such as ITO or they can be made of an opaque material such as copper but be sufficiently thin so that they are not visible in normal use. Examples of suitable materials are disclosed in U.S. Pat. No. 5,218,351.

The invention provides a lighting device which combines the LED in glass structure with switchable optical elements based upon an electrophoretic particle system.

Electrophoretic display devices are one example of display technology, which use the movement of charged electrophoretic particles within an electric field to provide a selective light scattering or absorption function. Bistable displays based on this technology are known. This invention uses this known display technology as a control device for controlling the light output of an illumination (rather than display) system.

In one example of electrophoretic display device, white particles are suspended in an absorptive liquid, and the electric field can be used to bring the particles to the surface of the device. In this position, they may perform a light scattering function, so that the display appears white. Movement away from the top surface enables the color of the liquid to be seen, for example black. In another example, there may be two types of particle, for example black negatively charged particles and white positively charged particles, suspended in a transparent fluid. There are a number of different possible configurations.

It has been recognized that electrophoretic display devices enable low power consumption as a result of their bistability (an image is retained with no voltage applied), and they can enable thin and bright display devices to be formed as there is no need for a backlight (for a reflective display) or polarizer. They may also be made from plastics materials, and there is also the possibility of low cost reel-to-reel processing in the manufacture of such displays.

If costs are to be kept as low as possible, passive addressing schemes are employed. The most simple configuration of display device is a segmented display, and there are a number of applications where this type of display is sufficient. A segmented electrophoretic display has low power consumption, good brightness and is also bistable in operation, and therefore able to display information even when the display is turned off.

However, improved performance and versatility is provided using a matrix addressing scheme. An electrophoretic display using passive matrix addressing typically comprises a lower electrode layer, a display medium layer, and an upper electrode layer. Biasing voltages are applied selectively to electrodes in the upper and/or lower electrode layers to control the state of the portion(s) of the display medium associated with the electrodes being biased.

Another type of electrophoretic display device uses so-called “in plane switching”. This type of device uses movement of the particles selectively laterally in the display material layer. When the particles are moved towards lateral electrodes, an opening appears between the particles, through which an underlying surface can be seen. When the particles are randomly dispersed, there is absorption and/or filtering of light. The particles may be colored and the underlying surface black or white, or else the particles can be black or white, and the underlying surface colored.

An advantage of in-plane switching is that the device can be adapted for transmissive operation, or transflective operation. In particular, the movement of the particles creates a passageway for light, so that both reflective and transmissive operation can be implemented through the material. This enables illumination using a backlight rather than reflective operation. The in-plane electrodes may all be provided on one substrate, or else both substrates may be provided with electrodes.

Active matrix addressing schemes are also used for electrophoretic displays, and these are generally required when a faster image update is desired for bright full color displays with high resolution greyscale. Such devices are being developed for signage and billboard display applications, and as (pixellated) light sources in electronic window and ambient lighting applications. Colors can be implemented using color filters or by a subtractive color principle, and the display pixels then function simply as greyscale devices.

The invention is based on the uses of an electrophoretic device as a control valve for controlling the light output from an array of light sources. The light sources are typically spaced quite far apart (more than 0.5 cm), and a rapid image update is not required. Instead, the electrophoretic control device is intended to enable lighting effects to be introduced. As a result, segmented addressing or passive matrix addressing will provide sufficient update speed and resolution.

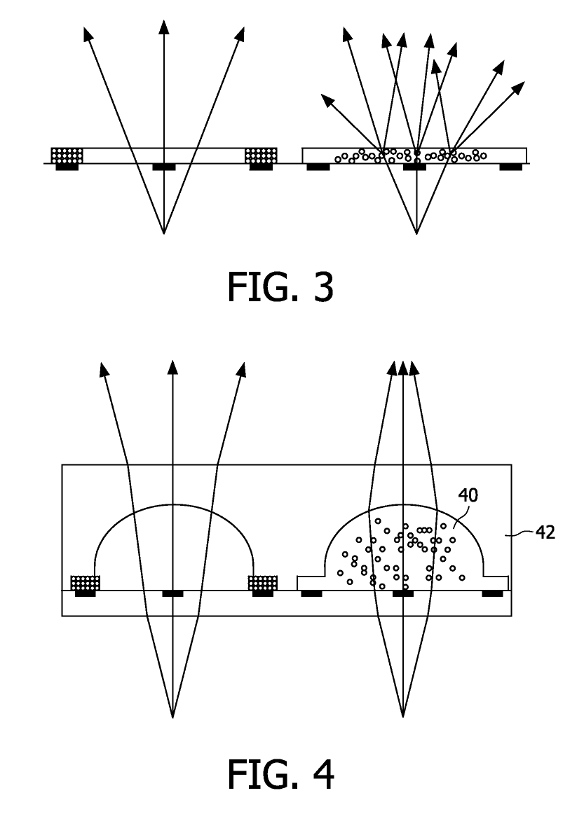

FIG. 3 shows in-plane operation of an electrophoretic control cell. The refractive index of the charged particles is different from that of the suspending medium.

The left image in FIG. 3 shows the scattering particles moved out of the path of a light beam from beneath the electrophoretic cell. This light beam can of course comprise the output of one of the LED devices. This provides a bright spot.

The right image in FIG. 3 shows the particles moved into a cavity in the light beam, resulting in a diffuse light output.

There are different classes of particle sizes that can be used. If the particle diameter is more than a few wavelengths (for example 1-50 μm), the particles scatter light. If the particles are brought into the light beam, diffuse light results as shown in FIG. 3. The amount of scattering can be changed by changing the particle concentration. Moreover, by changing the particle concentration locally, the amount of scattering in various directions can be made different.

If the particles are small enough to limit the amount of scattering (with a diameter of for example below 0.2 μm or more preferably below 0.1 μm), a liquid with a spatially and temporally variable refractive index can be realized. It should be made clear that the ‘particles’ are not limited to solid particles only. Liquid droplets or capsules filled with gas or liquids may also be used, provided they have a refractive index that is different from that of the surrounding fluid.

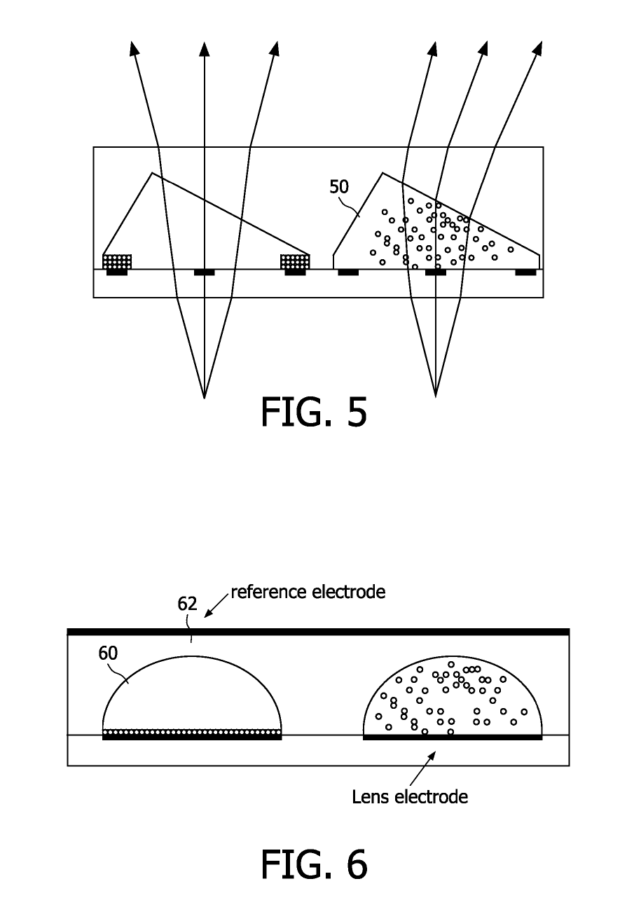

The use of small non-scattering particles can be used for changing the divergence of the light, as shown in FIG. 4, or to change the average direction as shown in FIG. 5.

In FIG. 4, a convex lens is shown, resulting in concentration of light. The left part of FIG. 4 shows no particles in the light path, resulting in a divergent beam. The right part of FIG. 4 shows the particles moved into a lens-shaped cavity in the light beam, resulting in a convergent beam.

If a concave lens is instead used, the result is a more diverging beam. In the example shown in FIG. 4, the refractive index of the fluid 40 is substantially the same as that of the material of the cavity 42 in which the liquid is contained, whereas the particles have a higher refractive index. Alternatively, particles that have a lower refractive index than the liquid may be used, in which case the lens geometry shown in FIG. 4 will also become a divergent lens when the particles are introduced.

In further examples, the refractive index of the fluid with particles distributed through the liquid can be chosen to be substantially the same as that of the material of the cavities 42, whereas the liquid itself when the particles are removed can have a lower or a higher refractive index.

FIG. 5 shows how the average light direction can be controlled using the electrophoretic particles. In the left part of FIG. 5, no particles are in the light path, so there is no change of the light direction. The right part of FIG. 5 shows particles moved into a prism-shaped cavity 50 in the light path, resulting in a change of the light direction.

FIGS. 3 to 5 show how an in-plane switching electrophoretic control device can be controlled. This has the advantage that a light opening can be provided to allow the uninterrupted passage the light output of the LED in glass structure.

FIG. 6 shows that perpendicular (transverse) switching can also be used. The left part of FIG. 6 shows all particles collected at the lower electrode within the cell volume 60, with no particles at the concave surface. This results in no lens action if the particles are small enough to be non-scattering, and if the refractive index of the fluid within the cell 60 matches that of the container 62. In the right part of FIG. 6, the particles are moved into a lens-shaped cavity in the light beam, resulting in a lens action.

The use of in-plane (lateral) particle movement can be combined with transverse (vertical) particle movement. For example, the arrangement of FIG. 4 could use a third electrode placed above the convex part of the lens. Particles can be brought from the lateral reservoirs to the lower central electrode. Then the higher central electrode can be used together with the reservoir electrodes. It then becomes possible to provide control of a 2- or 3-dimensional redistribution of particles, with Brownian motion increasing the response speed.

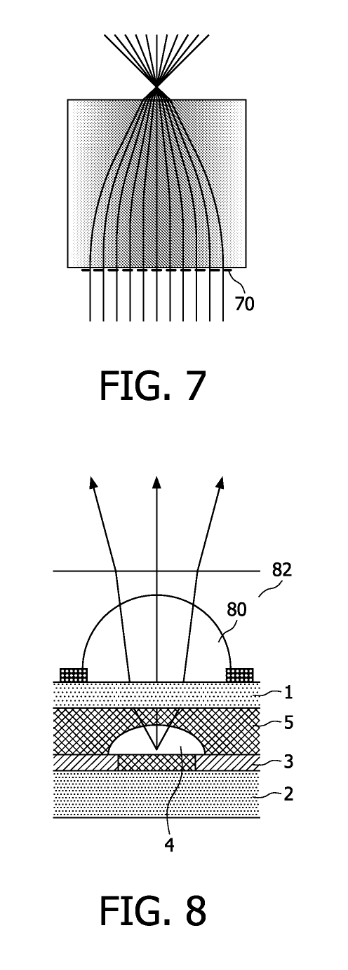

Electrophorectic cells can also be used to implement a graded refractive index lens, as shown in FIG. 7. The level of shading in FIG. 7 indicates the concentration of high-index particles. An electrode pattern 70 is shown schematically with the lines representing the field lines, and this gives rise to a distribution of particles resulting in a lens action.

The invention provides a combination of the LED in glass arrangement with an electrophoretic control arrangement which provides one or more of the effects explained above.

FIG. 8 shows the combined structure of the device of the invention.

The lower part of the device comprises a known LED in glass device, as shown in FIG. 2, and the same reference numerals are used.

The top glass substrate 1 of the LED in glass device is shared as the lower substrate of the electrophoretic control device. The other layers of the device of FIG. 8 comprise the cell liquid 80 and body of the device 82 which defines the cell volumes.

The figures above each show two dimensional cross sections of proposed devices. In three dimensions, additional control measures can be implemented (known in the art) to shape the beam in the third direction, for example, cylindrical lenses vs. spherical lenses.

Only one example of electrophoretic control device has been shown. The electrophoretic control device can comprise a single type of particle, or multiple particles. The use of multiple particles of different color can be used to convert a white LED output into a desired color output, for example by using particles which absorb light frequency components (a so-called subtractive color system). In addition to simply absorbing different frequency components, the scattering refraction or diffraction functions can be maintained, but with wavelength-dependent properties, so that some frequency components are absorbed and others are scattered, refracted or diffracted. In this way, light of different colors can be manipulated in different ways.

Thus, the electrophoretic control device can thus be used for color control, direction control, light uniformity control (between a light spot output and a uniform output), or combinations of these effects.

The device may also use diffraction gratings (on the top or bottom surface), again to manipulate the directions and color of the light.

The electrophoretic control device can use an electrode arrangement which generates an electric field in which particles move under the influence of a dielectrophoretic, electro-hydrodynamic or electro-osmotic force.

The electrophoretic control device may be driven with ac or dc drive signals.

The examples above have shown a small array of light sources. However, it will be understood that the invention is typically implemented as many LED devices, embedded in a large glass plate. A typical distance between the LEDs may be 1 cm to 10 cm, for example approximately 3 cm.

Each light source may also comprise a single LED or multiple LEDs.

The examples above use glass substrates, but it will be apparent that plastic substrates may also be used.

Various modifications will be apparent to those skilled in the art.

1. A light output device, comprising:
a substrate arrangement,
at least one discrete light source device for generating light output, the light source device being integrated into the substrate arrangement;
an electrophoretic switchable light control device comprising at least one controllable region associated with the light source device, the electrophoretic switchable light control device being stacked with the substrate arrangement and configured for focusing and/or redirecting of the light output from the light source device.

2. A device as claimed in claim 1, comprising a plurality of light source devices, and wherein the electrophoretic switchable light control device comprises a plurality of controllable regions.

3. A device as claimed in claim 1, wherein the light source device (4) comprises an LED device or a group of LED devices.

4. (canceled)

5. A device as claimed in claim 1 comprising an array of discrete light source devices with a spacing between light source devices of at least 0.5 cm.

6. A device as claimed in claim 1, wherein the substrate arrangement comprises first and second transparent substrates and an electrode arrangement embedded in the substrate arrangement.

7. A device as claimed in claim 6, wherein a thermoplastic or resin layer is provided between the substrates.

8. A device as claimed in claim 6, wherein the electrode arrangement is formed of a transparent conductive material.

9. (canceled)

10. A device as claimed in claim 6, wherein the first transparent substrate of the substrate arrangement forms a bottom substrate of the electrophoretic light control device.

11. A device as claimed in claim 1, wherein the electrophoretic light control device comprises scattering electrophoretic particles, and wherein the amount and/or directionality of scattering is manipulated by changing the particle concentration above the light source device.

12. (canceled)

13. A device as claimed in claim 1, wherein the electrophoretic switchable light control device comprises particles which are arranged such that they diffract light.

14. A device as claimed in claim 10, wherein the electrophoretic switchable light control device comprises particles with a first refractive index in a liquid of a different refractive index.

15. A device as claimed in claim 13, wherein the electrophoretic switchable light control device comprises a suspending medium containing particles, wherein a relatively low concentration of suspended particles in the medium gives rise to a higher or lower refractive index than a relatively high concentration of suspended particles.

16. (canceled)

17. A device as claimed in claim 1, wherein the electrophoretic switchable light control device comprises particles and a suspending medium which are enclosed in a cavity formed within a body.

18. A device as claimed in claim 6, wherein the electrophoretic switchable light control device comprises particles which are controllably movable substantially perpendicularly relative to the electrode arrangement.

19. A device as claimed in claim 1, wherein the electrophoretic switchable light control device comprises particles which are controllably movable substantially laterally relative to the electrode arrangement.

20. (canceled)
